(19) United States
(12) Patent Application Publication
(10) Pub. No.: US 2026/0053701 A1
(43) Pub. Date: Feb. 26, 2026

(54) APPARATUS HAVING A VIBRATION FUNCTION, IN PARTICULAR SHOWER HEAD HAVING A VIBRATION FUNCTION

(71) Applicant: VIBR. GMBH, Weinitzen (AT)

(72) Inventors: Julian PIRCHER, Graz (AT); Christian RABL, Weinitzen (AT)

(21) Appl. No.: 19/120,504

(22) PCT Filed: Oct. 14, 2022
(86) PCT No.: PCT/EP2022/078709

§ 371 Date: Apr. 11, 2025

(51) Int. Cl. A61H 23/04; A61H 19/00; B05B 1/08; E03C 1/04

(52) U.S. Cl. CPC A61H 23/04; A61H 19/00; B05B 1/083; E03C 1/0408; A61H 2201/1246; A61H 2201/5053

(57) ABSTRACT

The present disclosure relates to an apparatus, in particular a shower head (100), having a water-driven or water-powered vibration function for massage purposes and/or for sexual stimulation. The shower head (100) preferably includes a hollow longitudinal main body (1), a water inlet (2) arranged on one side of the hollow longitudinal main body (1), one or more water outlets la arranged on another side of the hollow longitudinal main body (1), a vibration member (8) arranged inside the hollow longitudinal main body (1) between the water inlet (2) and the one or more water outlets la, and a switching mechanism (11) configured to switch between a first state in which the vibration member (8) is movably released inside at least a portion of the hollow longitudinal main body (1) and a second state in which a position of the vibration member (8) is fixed.

### DESCRIPTION

The present disclosure relates to an apparatus having a vibration function for massage purposes and/or for sexual stimulation, in particular a shower head having a vibration function for massage purposes and/or for sexual stimulation. The present disclosure specifically relates to an apparatus having a water-driven or water-powered vibration function for massage purposes and/or for sexual stimulation, in particular a shower head having a water-driven or water-powered vibration function for massage purposes and/or for sexual stimulation.

### BACKGROUND

In the background prior art, it is known to provide apparatuses having a vibration function for massage purposes and/or for sexual stimulation, in particular apparatuses having a water-driven or water-powered vibration function for massage purposes and/or for sexual stimulation, in particular a shower head having a water-driven or water-powered vibration function for massage purposes and/or for sexual stimulation.

For example, representing an apparatus having a vibration function according to the closest prior art, the patent document AT 51 37 17 A1 relates to an apparatus having a water-driven or water-powered vibration function for massage purposes and/or for sexual stimulation. In AT 51 37 17 A1, a longitudinal hollow body of the apparatus has a water inlet and one or more water outlets (shower nozzles) on opposing sides of the longitudinal hollow body. A vibration member is provided inside of the longitudinal hollow body and, in a vibrating position, the vibration member is allowed to move within a cavity inside the longitudinal hollow body between the water inlet and the water outlets, and water flowing from the water inlet and around the vibration member to the water outlets drives a water-powered vibration movement of the vibration member. In examples of AT 51 37 17 A1, the apparatus is embodied by a shower head. However, the vibration operation of the apparatus of AT 51 37 17 A1 cannot be switched off other than by cutting off the water supply to the water inlet of the apparatus.

Patent document WO 99/22875 relates to shower pulsator with a vibrating ball. Similar to AT 51 37 17 A1, the vibration operation of the apparatus of AT 51 37 17 A1 cannot be switched off other than by cutting off the water supply to the water inlet of the apparatus.

Patent document KR 2013/0009078 A relates to a vibrating shower device having a massage function. The vibrating shower device of KR 2013/0009078 A has a vibration member that is allowed to move within a ring portion inside the shower device water flowing from the water inlet drives the vibration member along and around the ring portion. However, even when water flow to the vibration member is restricted, the vibration member is still allowed to move freely inside ring portion, which leads to a disadvantageous user experience. Furthermore, the mechanism of KR 2013/0009078 A is quite complicated because a switch mechanism is provided to divert water flow between two paths depending on a switch position.

Patent document U.S. Pat. No. 5,467,927 A relates to a shower head with selectively usable vibrating and pulsating member. The mechanism of U.S. Pat. No. 5,467,927 A is quite complicated because a switch mechanism is provided to divert water flow between two paths depending on a switch position and the vibration function is generated by a rotating turbine having an eccentric weight inside the shower head.

Patent document US 2011/266363 A1 relates to a shower head with water-powered vibrating function. The mechanism of US 2011/266363 A1 is quite complicated because the vibration function is generated by a rotating turbine driving an eccentric wheel inside the shower head.

Patent document U.S. Pat. No. 4,209,132 A relates to a shower spray head having a water-powered vibration function based on a rotating turbine driving an eccentric member inside the shower spray head.

In view of the above prior art, it is an object of the present disclosure to provide an improved apparatus providing a water-driven or water-powered vibration function, in particular having a less complex vibration mechanism and/or more convenient user handling.

In particular, starting from the closest prior art of AT 51 37 17 A1, it is an object of the present disclosure to preferably provide an improved apparatus providing a water-driven or water-powered vibration function in which the vibration function can be conveniently switched off or deactivated independently of the water supply, in particular in which the vibration function can be conveniently switched off or deactivated during active water flow from a water inlet side to a water outlet side.

### SUMMARY

In view of one or more of the above objects, there is proposed an apparatus having a vibration function according to the independent claim 1 and a shower head comprising such an apparatus having a vibration function. Dependent claims relate to exemplary preferred embodiments.

In accordance with an aspect of the present disclosure, there is proposed an apparatus having a vibration function. The apparatus preferably comprises a hollow longitudinal main body, a water inlet which is preferably arranged on one side of the hollow longitudinal main body, and/or one or more water outlets which is/are preferably arranged on another side of the hollow longitudinal main body. The apparatus may preferably comprise a vibration member which may preferably be arranged inside the hollow longitudinal main body, in particular preferably along a water path between the water inlet and the one or more water outlets. The apparatus may preferably comprise a switching mechanism which may preferably be configured to switch between a first state and a second state and/or vice versa. Preferably, the vibration member may be movably released inside at least a portion of the hollow longitudinal main body in the first state of the switching mechanism and/or a position of the vibration member may be fixed in the second state of the switching mechanism.

According to exemplary preferred aspects, the vibration member may preferably be configured, in particular when the switching mechanism is in the first state, to perform a vibration movement. Preferably, the vibration movement may be powered by water flowing from the water inlet to the one or more water outlets, the water flow preferably passing the vibration member between the water inlet and the one or more water outlets.

According to exemplary preferred aspects, the position of the vibration member may preferably remain fixed, in particular when the switching mechanism is in the second state, preferably while water flow passes the vibration member between the water inlet and the one or more water outlets.

According to exemplary preferred aspects, the vibration function may preferably be switched on when the switching mechanism is in the first state, and/or the vibration function may preferably be switched off when the switching mechanism is in the second state.

According to exemplary preferred aspects, the switching mechanism may preferably be configured to mechanically switch between the first and second state and/or vice versa.

According to exemplary preferred aspects, the switching mechanism may preferably include a mechanical bistable mechanism, in particular preferably a mechanical bistable mechanism which may preferably operate similar to a retractable pen mechanism such as a push-push mechanism which preferably can be transitioned between first and second positions and/or vice versa by respective push operations.

According to exemplary preferred aspects, the apparatus may preferably include a button member preferably arranged at one end of the hollow longitudinal main body, in particular preferably opposite the side of the water inlet. The button member may preferably be configured to activate switching of the switching mechanism between the first and second states and/or vice versa.

According to exemplary preferred aspects, the apparatus may preferably include a plunger preferably arranged inside the hollow longitudinal main body and/or being preferably configured to move in the longitudinal direction of the hollow longitudinal main body, in particular preferably in an axial direction of the hollow longitudinal main body, wherein the hollow longitudinal main body may preferably include a cylindrical shape.

According to exemplary preferred aspects, the switching mechanism may preferably include a movable member being preferably configured to move in the longitudinal direction of the hollow longitudinal main body, in particular preferably in an axial direction of the hollow longitudinal main body, wherein the hollow longitudinal main body may preferably include a cylindrical shape.

According to exemplary preferred aspects, the movable member of the switching mechanism may preferably be configured to move in the longitudinal direction of the hollow longitudinal main body, preferably between a first stable position, in particular a retracted stable position relative to a fixed member of the switching mechanism, and a second stable position, in particular a retracted position relative to a fixed member of the switching mechanism, and/or vice versa.

According to exemplary preferred aspects, the movable member of the switching mechanism may preferably be positioned in the first stable position when the switching mechanism is in the first state, and/or the movable member of the switching mechanism may preferably be positioned in the second stable position when the switching mechanism is in the second state.

According to exemplary preferred aspects, the vibration member may preferably be fixedly held between the plunger and the movable member of the switching mechanism preferably when the switching mechanism is in the second state.

According to exemplary preferred aspects, a holding member may preferably be fixedly attached to the movable member of the switching mechanism preferably on a side facing the vibration member. Preferably, the vibration member may preferably be fixedly held between the plunger and the holding member, preferably when the switching mechanism is in the second state, in particular preferably such that an axial position of the vibration member may preferably be fixedly held between the plunger and the holding member when the switching mechanism is in the second state and/or a radial position of the vibration member may preferably be fixedly held between the plunger and the holding member when the switching mechanism is in the second state and/or when the holding member engages with the vibration member in the second state.

According to exemplary preferred aspects, the vibration member may preferably be a spherical ball member, in particular preferably a ball member including metal or being made from metal.

According to yet further exemplary preferred aspects, there is proposed a shower head comprising an apparatus according to at least one or more or all of the preceding exemplary aspects.

While certain exemplary aspects have been described above, it is to be understood that such aspects are merely illustrative of (and are not to be understood restrictive on) the broad invention and present disclosure, and that the exemplary aspects are not limited to the specific constructions and arrangements shown and described above or below, since various other changes, combinations, omissions, modifications and substitutions, in addition to those set forth in the above or below description, are possible. Those skilled in the art will appreciate that various adaptations, modifications, and/or combination of the just described aspects can be configured or be provided. Therefore, it is to be understood that further aspects may be practiced other than as specifically described herein. For example, unless expressly stated otherwise, the steps of processes described herein may be performed in orders different from those described herein and one or more steps may be combined, split, or performed simultaneously. Those skilled in the art will also appreciate, in view of this disclosure, that different aspects described herein may be combined to form other aspects of the present disclosure.

### BRIEF DESCRIPTION OF DRAWINGS

FIG. 1 exemplarily shows an illustrative perspective view shower head according to exemplary embodiments,

FIG. 2 exemplarily shows a longitudinal cross section of the shower head according to FIG. 1 in a first state,

FIG. 3 exemplarily shows a longitudinal cross section of the shower head according to FIG. 1 in a second state, and

FIG. 4 exemplarily shows a longitudinal cross section of the shower head according to FIG. 1 in a third state.

### DETAILED DESCRIPTION OF THE DRAWINGS AND EXEMPLARY EMBODIMENTS

In the following, preferred exemplary aspects and exemplary embodiments of the present invention will be described in more detail with reference to the accompanying figures. Same or similar features in different drawings and exemplary embodiments are referred to by similar reference numerals. It is to be understood that the detailed description below relating to various preferred exemplary aspects and preferred exemplary embodiments are not to be meant as limiting the scope of the present invention.

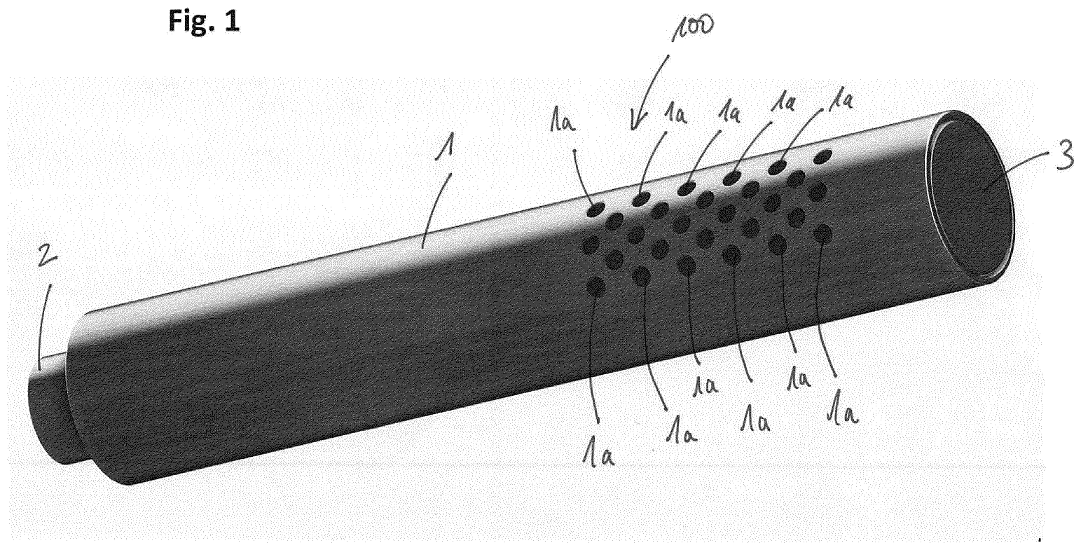

FIG. 1 exemplarily shows an illustrative perspective view shower head 100 (apparatus) according to exemplary embodiments.

The shower head 100 (apparatus) exemplarily includes a main body 1. Exemplarily, the main body 1 has plural water outlets 1a (e.g. shower head nozzles) which are exemplarily arranged on at least one side of the main body 1 of the shower head 100 within an area close or adjacent to a front portion of the main body 1 of the shower head 100. Exemplarily on an opposite side, a water inlet member 2 is exemplarily arranged, for example, at an end portion of the main body 1

The water inlet member 2 can exemplarily be embodied as a standard water inlet of a shower head. For example, the water inlet member 2 can include a threaded portion for attachment to a shower hose (not shown) having a standardized threaded connecting interface such as, for example, a standard shower hose connector coupling. For example, the water inlet member 2 can exemplarily include a standard ½ inch threaded portion for attachment of a shower hose (shower tube).

In preferred exemplary aspects, the water inlet member 2 can include metal or be made from metal, such as aluminum, titanium, steel (e.g. corrosion-resistant steel, such as stainless steel), etc. Also, the water inlet member 2 can include or be made from plastics. The material is preferably provided to be corrosion-resistant.

Further exemplarily, a pressable button member 3 is arranged at a front portion of the main body 1 of the shower head 100. As will be described in more detail in the following, the pressable button member 3 is provided so that the vibration function of the shower head 100 can be switched on and off.

In preferred exemplary aspects, the button member 3 can include metal or be made from metal, such as aluminum, titanium, steel (e.g. corrosion-resistant steel, such as stainless steel), etc. Also, the button member 3 can include or be made from plastics. The material is preferably provided to be corrosion-resistant.

Further exemplarily, the main body 1 is provided as a longitudinal hollow body, exemplarily having a substantially cylindrical shape.

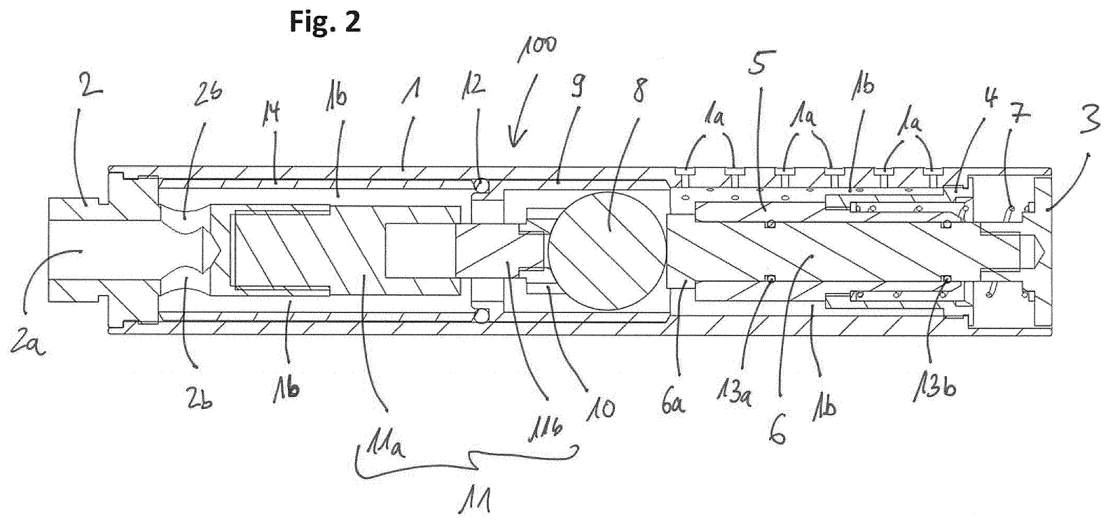

FIG. 2 exemplarily shows a longitudinal cross section of the shower head 100 according to FIG. 1 in a first state, specifically exemplarily in a state with a vibration function being switched off.

As exemplarily shown in FIG. 2, the end portion (left-hand side) of the longitudinal hollow main body 1 is sealed with the water inlet member 2. The water inlet member 2 exemplarily includes a longitudinal (axially arranged) water inlet hole 2a connected to the (radially arranged) water inlet holes 2b. The water inlet holes 2a and 2b can be provided as boreholes, for example.

Supplied water is exemplarily allowed to enter the inner hollow space 1b of the longitudinal hollow main body 1 through the longitudinal water inlet hole 2a and the water inlet holes 2b. Such water flow can be supplied by pressurized water from a connected shower hose (not shown), for example.

As further exemplarily shown in FIG. 2, the front portion (right-hand side) of the longitudinal hollow main body 1 is exemplarily sealed by a bushing member 4. In preferred exemplary aspects, the bushing member 4 can include metal or be made from metal, such as aluminum, titanium, steel (e.g. corrosion-resistant steel, such as stainless steel), etc. Also, the bushing member 4 can include or be made from plastics. The material is preferably provided to be corrosion-resistant.

The bushing member 4 exemplarily holds a guiding member 5 which exemplarily holds a plunger 6. In preferred exemplary aspects, the guiding member 5 and/or the plunger 6 can include metal or be made from metal, such as aluminum, titanium, steel (e.g. corrosion-resistant steel, such as stainless steel), etc. Also, the guiding member 5 and/or the plunger 6 can include or be made from plastics. The material is preferably provided to be corrosion-resistant.

The plunger 6 is exemplarily arranged and configured to move in a longitudinal (axial) direction of the longitudinal hollow main body 1. For example, the guiding member 5 can include an axial borehole which exemplarily can receive the plunger 6 in the longitudinal (axial) direction of the longitudinal hollow main body 1.

Exemplarily, the outer diameter of the plunger 6 can be fitted to the inner diameter of the axial borehole of the guiding member 5 so that the plunger 6 received in the axial borehole of the guiding member 5 is configured to slide in the longitudinal (axial) direction of the longitudinal hollow main body 1.

Exemplarily, the button member 3 is exemplarily arranged at a front end of the plunger 6 and the button member 3 exemplarily closes a front opening of the longitudinal hollow main body 1 (see also FIG. 1).

Exemplarily, the button member 3 is fixedly attached to the front end of the plunger 6. For example, the button member 3 can be fixedly attached to the front end of the plunger 6 by a screw connection, e.g. the button member 3 can be screwed onto the front end of the plunger 6.

Further exemplarily, the back end of the plunger 6 comprises a widened stopper portion 6a restricting the axial movement of the plunger 6 towards the outside of the longitudinal hollow main body 1, when the stopper portion 6a of the plunger 6 comes into contact with the inner end portion of the guiding member 5 as exemplarily illustrated in FIG. 2.

Further exemplarily, a biasing member 7, such as, e.g., a spring or preferably metal spring, biases the plunger 6, preferably together with the button member 3, towards the outside of the longitudinal hollow main body 1 until the stopper portion 6a of the plunger 6 comes into contact with the inner end portion of the guiding member 5 as exemplarily illustrated in FIG. 2.

Exemplarily, two sealing members 13a and 13b, such as, e.g., O-rings, are provided between the guiding member 5 and the plunger 6 moving in the guiding member 5.

Further exemplarily, a hollow cage member 9 is fitted inside the longitudinal hollow main body 1 arranged at substantially a middle portion of the longitudinal hollow main body 1. The hollow cage member 9 can have a cylindrical shape, e.g. as a hollow cylindrical member.

The hollow cage member 9 is exemplarily held in place by a distancing member 14 arranged between the water inlet member 2 and the hollow cage member 9. Exemplarily, a sealing member 12, such as, e.g., an O-ring, is provided between the hollow cage member 9 and the distancing member 14. Exemplarily, the distancing member 14 can have a cylindrical shape, e.g. as a hollow cylindrical member.

In preferred exemplary aspects, the hollow cage member 9 and/or the distancing member 14 can include metal or be made from metal, such as aluminum, titanium, steel (e.g. corrosion-resistant steel, such as stainless steel), etc. Also, the hollow cage member 9 and/or the distancing member 14 can include or be made from plastics. The material is preferably provided to be corrosion-resistant.

Further exemplarily, a vibration member 8 is provided inside the hollow cage member 9. Herein, the diameter of the vibration member 8 is preferably slightly smaller than an inner diameter of the hollow cage member 9 so that a small gap (e.g. a small gap of about 1 mm or less) is provided between the inner walls of the hollow cage member 9 and the vibration member 8, in particular preferably so that water can flow from the water inlet member 2 to the plural water outlets 1a at the front portion of the longitudinal hollow main body 1 through the hollow space 1b of the longitudinal hollow main body 1 passing the gap between the inner walls of the hollow cage member 9 and the vibration member 8.

In preferred exemplary aspects, the vibration member 8 can include metal or be made from metal, such as aluminum, titanium, steel (e.g. corrosion-resistant steel, such as stainless steel), etc. Also, the vibration member 8 can include or be made from plastics. The material is preferably provided to be corrosion-resistant.

Further exemplarily, a switching mechanism 11 is provided within the longitudinal hollow main body 1. The switching mechanism 11 exemplarily includes a fixed member 11a which is exemplarily fixedly arranged within the longitudinal hollow main body 1.

Exemplarily, the fixed member 11a is fixedly attached to the water inlet member 2. For example, the fixed member 11a of the switching mechanism 11 can be fixedly attached to an end of the water inlet member 2 by a screw connection, e.g. the fixed member 11a of the switching mechanism 11 can be screwed onto an end of the water inlet member 2.

The switching mechanism 11 further exemplarily includes a movable member 11b which is exemplarily configured to move in the longitudinal (axial) direction of the longitudinal hollow main body 1 relative to the fixed member 11a of the switching mechanism 11.

In preferred exemplary aspects, the fixed member 11a of the switching mechanism 11 and/or the movable member 11b of the switching mechanism 11 can include metal or be made from metal, such as aluminum, titanium, steel (e.g. corrosion-resistant steel, such as stainless steel), etc. Also, the fixed member 11a of the switching mechanism 11 and/or the movable member 11b of the switching mechanism 11 can include or be made from plastics. The material is preferably provided to be corrosion-resistant.

Exemplarily, a holding member 10 is arranged at the movable member 11b at a side thereof facing the vibration member 8. Exemplarily, the holding member 10 is fixedly attached to the movable member 11b of the switching mechanism 11. For example, the holding member 10 can be fixedly attached to an end the movable member 11b of the switching mechanism 11 by a screw connection, e.g. the holding member 10 can be screwed onto an end of the movable member 11b of the switching mechanism 11.

In preferred exemplary aspects, the holding member 10 can include metal or be made from metal, such as aluminum, titanium, steel (e.g. corrosion-resistant steel, such as stainless steel), etc. Also, holding member 10 can include or be made from plastics. The material is preferably provided to be corrosion-resistant.

Exemplarily, the holding member 10 can have an engaging portion for engaging with the vibration member 8. Preferably, the engaging portion of the holding member 10 can come into contact with the vibration member 8 so as to maintain (restrict) the radial position of the vibration member 8, when the holding member 10 engages with the vibration member 8.

In the state of FIG. 2, the axial position of the vibration member 8 is exemplarily fixed in that the vibration member 8 is held between the plunger 6 and the holding member 10, when the holding member 10 engages with the vibration member 8.

In this state, the position of the vibration member 8 is exemplarily fixed in that the axial position of the vibration member 8 is fixed by being held between the plunger 6 and the holding member 10 and, further preferably, the radial position of the vibration member 8 is exemplarily fixed by the shape of the engaging portion of the holding member 10, when the holding member 10 engages with the vibration member 8. Accordingly, in the state of FIG. 2, axial and/or radial movement of the vibration member 8 is exemplarily restricted by the holding member 10 and the plunger 6, when the holding member 10 engages with the vibration member 8.

Still, in the state of FIG. 2, water can exemplarily flow around the vibration member 8 through the gap between the inner walls of the hollow cage member 9 and the vibration member 8 from the water inlet member 2 to the plural water outlets la at the front portion of the longitudinal hollow main body 1, and the shower head can be used for normal shower operations without any vibration (vibration function switched off).

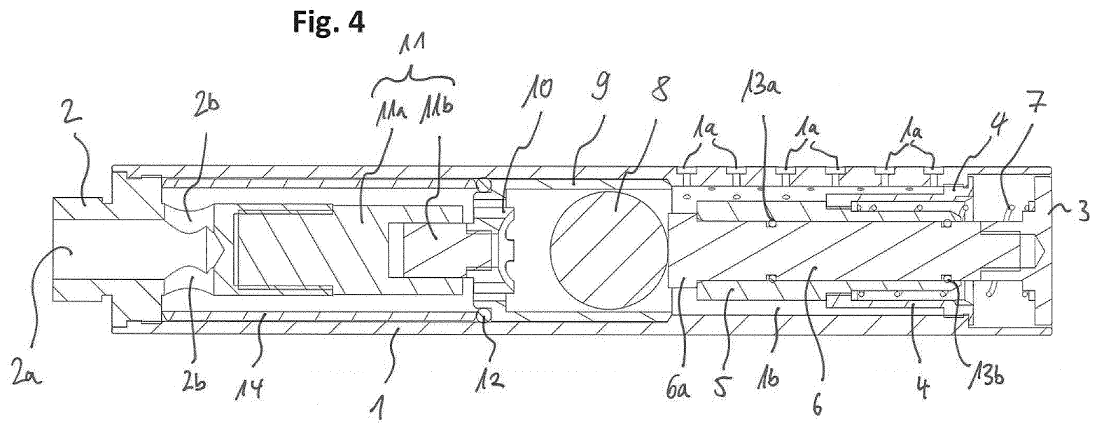

Exemplarily, the switching mechanism 11 is configured as a push-push-mechanism, preferably similar to a retractable pen mechanism. Accordingly, the switching mechanism 11 can take two stable positions (bistable mechanism) as shown in FIGS. 2 and 4, respectively. The switching mechanism 11 is exemplarily configured to switch between each of the two stable positions by pushing the movable member 11b of the switching mechanism 11.

For example, in a first position (extended position) as exemplarily shown in FIG. 2, the movable member 11b of the switching mechanism 11 is extended away from the fixed member 11a of the switching mechanism 11 in the longitudinal (axial) direction of the longitudinal hollow main body 1.

Further exemplarily, in the second position (retracted position) as exemplarily shown in FIG. 4, the movable member 11b of the switching mechanism 11 is retracted towards the fixed member 11a of the switching mechanism 11 in the longitudinal (axial) direction of the longitudinal hollow main body 1.

The respective positions as shown in FIGS. 2 and 4 exemplarily illustrate the two stable positions of the switching mechanism 11, respectively, and transitioning from one position to the other position can respectively be effected (activated) by pushing the movable member 11b of the switching mechanism 11 in the longitudinal (axial) direction from the side of the button member 3 (e.g. similar to the push mechanism of a retractable pen, where pushing the button switches between the retracted and extended positions and vice versa).

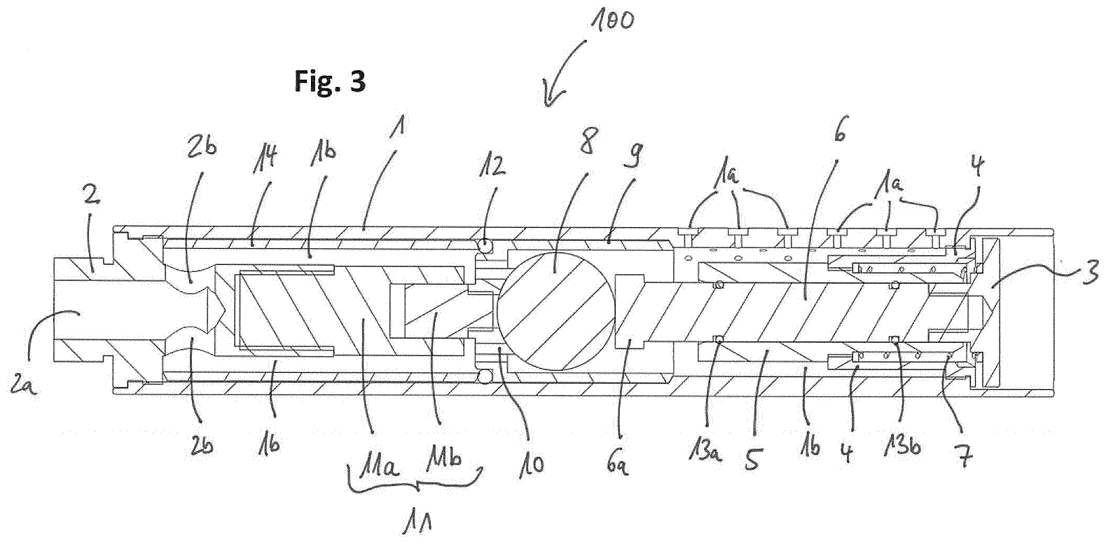

FIG. 3 exemplarily shows a longitudinal cross section of the shower head 100 according to FIG. 1 in a second state, specifically exemplarily in a transitional state during switching on the vibration function.

Accordingly, when the button member 3 is pushed inwards as exemplarily shown in FIG. 3, the plunger 6 is moved longitudinally (axially) inwards and exemplarily pushes the vibrating member 8 against the holding member 10 towards the switching mechanism 11 and thereby the movable member 11b of the switching mechanism 11 is exemplarily pushed from the first (extended) position longitudinally (axially) towards the fixed member 11a of the switching mechanism 11 into the second (retracted) position, which is the second stable position of the (bistable) switching mechanism 11.

FIG. 4 exemplarily shows a longitudinal cross section of the shower head 100 according to FIG. 1 in a third state, specifically exemplarily in a state with a vibration function being switched on.

Accordingly, when the button member 3 is released and is moved again towards the outside of the longitudinal hollow main body 1 together with the plunger 6 by the biasing force of the biasing member 7, preferably until the stopper portion 6a comes into contact with the guiding member 5, the movable member 11b of the switching mechanism 11 exemplarily remains in the second (retracted) position of the switching mechanism 11. This is exemplarily shown in FIG. 4.

In this state of FIG. 4 with the second (retracted) position of the switching mechanism 11, the vibration member 8 is exemplarily released due to the larger distance between the holding member 10 and the plunger 6 and the vibration member 8 exemplarily can move freely in the hollow cage member 9 in this state.

Exemplarily, when water flows around the vibration member 8 through the gap between the inner walls of the hollow cage member 9 and the vibration member 8 from the water inlet member 2 to the plural water outlets la at the front portion of the longitudinal hollow main body 1, the vibration member 8 is exemplarily moved by the flowing water inside the hollow cage member 9 and thereby generates a vibration of the longitudinal hollow main body 1 (vibration function switched on).

As an exemplary technical effect, the intensity, strength and/or frequency of vibration movement of the vibration member 8 inside the hollow cage member 9 can be continuously controlled by controlling the water pressure and/or water flow. Specifically, higher water flow exemplarily generates higher frequencies of vibration movement of the vibration member 8 inside the hollow cage member 9. Accordingly, the water powered or water driven vibration function can be switched on and off independent of water flow in the absence of any electromagnetic mechanism and, further exemplarily, the intensity and/or frequency of vibration can be continuously and conveniently controlled by controlling the water flow in the absence of any electromagnetic mechanism.

In preferred exemplary embodiments, the vibration member 8 is exemplarily embodied as a ball member (see e.g. FIGS. 2 to 4). Then, the water flowing around the vibration member 8 through the gap between the inner walls of the hollow cage member 9 and the vibration member 8 from the water inlet member 2 to the plural water outlets la at the front portion of the longitudinal hollow main body 1 powers a rotation of the vibration member 8 (ball member) and exemplarily generates a smooth vibration of the longitudinal hollow main body 1 (smooth vibration function switched on).

On the other hand, when the button member 3 is pushed again inwards as exemplarily shown in FIG. 3, the plunger 6 is exemplarily moved longitudinally (axially) inwards until it pushes the vibrating member 8 against the holding member 10 towards the switching mechanism 11 and thereby the movable member 11b of the switching mechanism 11 is exemplarily briefly pushed to switch the stable states.

Then, when the button member 3 is released and is moved again towards the outside of the longitudinal hollow main body 1 together with the plunger 6 by the biasing force of the biasing member 7, preferably until the stopper portion 6a comes into contact with the guiding member 5, the movable member 11b of the switching mechanism 11 exemplarily also moves from the second (retracted) position of the switching mechanism 11 towards the first (extended) position of the switching mechanism 11 as exemplarily shown in FIG. 1. In this state, the vibration member 8 is again fixedly held between the plunger 6 and the holding member 10 (vibration function switched off) without interruption of the water flow or without the requirement of interruption of the water flow.

Accordingly, in the above exemplary embodiments, a shower head can be provided with a simple, efficient and convenient mechanism providing a water-powered vibration function that can be conveniently and efficiently switched on and off, respectively, independent of water supply and also during shower operations without interrupting the water flow. Furthermore, no electromagnetic mechanism is needed, and the switching and vibration mechanisms require low to zero maintenance.

In preferred exemplary embodiments, while the longitudinal hollow main body 1 can include or be made of plastics in other exemplary embodiments, the longitudinal hollow main body 1 can include or be made of metal, such as aluminum, titanium or steel (e.g. corrosion-resistant steel, such as stainless steel). The material is preferably provided to be corrosion-resistant.

When the longitudinal hollow main body 1 is made of metal or includes metal, then the temperature of the material of the longitudinal hollow main body 1 takes the temperature of the water flowing from the inlet side to the outlet side. Accordingly, the temperature of the longitudinal hollow main body 1 coming into contact with a human body can be conveniently controlled continuously according to the user preference by controlling the temperature of the supplied flowing water.

In the above exemplary embodiments, the elongated main body 1 was exemplarily provided having a cylindrical outer shape. Of course, other shapes are possible as well and the elongated main body 1 can be shaped in various elongated shapes and can even be provided as a free-form shape (e.g. milled or 3D-printed according to a 3D model such as a CAD model, etc.). For efficient, simple and cost-efficient assembly, the inner hollow space of the elongated main body 1 is still preferably substantially a cylindrical hollow inner space independent of the outer shape. This allows to assemble the inner mechanisms of the apparatus in a similar manner to the above exemplary embodiments, while the outer shape of the main body 1 can be chosen according to design preferences.

While certain exemplary embodiments have been described above and shown in the accompanying drawings, it is to be understood that such embodiments are merely illustrative of and are not restrictive on the broad invention, and that the embodiments of invention are not limited to the specific constructions and arrangements shown and described, since various other changes, combinations, omissions, modifications and substitutions, in addition to those set forth in the above paragraphs, are possible. Those skilled in the art will appreciate that various adaptations, modifications, and/or combination of the just described embodiments can be configured without departing from the scope and spirit of the invention. Therefore, it is to be understood that, within the scope of the appended claims, the invention may be practiced other than as specifically described herein. For example, unless expressly stated otherwise, the steps of processes described herein may be performed in orders different from those described herein and one or more steps may be combined, split, or performed simultaneously. Those skilled in the art will also appreciate, in view of this disclosure, that different embodiments of the invention described herein may be combined to form other embodiments of the invention.

1. An apparatus having a vibration function, in particular a water-powered or water-driven vibration function, the apparatus comprising:
a hollow longitudinal main body,
a water inlet arranged on one side of the hollow longitudinal main body,
one or more water outlets arranged on another side of the hollow longitudinal main body,
a vibration member arranged inside the hollow longitudinal main body along a water path between the water inlet and the one or more water outlets, and
a switching mechanism configured to switch between a first state, in which the vibration member is movably released inside at least a portion of the hollow longitudinal main body, and a second state, in which a position of the vibration member is fixed.

2. The apparatus according to claim 1, wherein
the vibration member is configured, when the switching mechanism is in the first state, to perform a vibration movement powered by water flowing from the water inlet to the one or more water outlets, the water flow passing the vibration member between the water inlet and the one or more water outlets.

3. The apparatus according to claim 1, wherein
the position of the vibration member remains fixed, when the switching mechanism is in the second state, while water flow passes the vibration member between the water inlet and the one or more water outlets.

4. The apparatus according to claim 1, wherein
the vibration function is switched on when the switching mechanism is in the first state, and/or
the vibration function is switched off when the switching mechanism is in the second state.

5. The apparatus according to claim 1, wherein
the switching mechanism is configured to mechanically switch between the first and second state.

6. The apparatus according to claim 1, wherein
the switching mechanism includes a mechanical bistable mechanism, in particular a mechanical bistable mechanism operating similar to a retractable pen mechanism.

7. The apparatus according to claim 1, further comprising
a button member arranged at one end of the hollow longitudinal main body, in particular opposite the side of the water inlet, the button member being configured to activate switching of the switching mechanism between the first and second states.

8. The apparatus according to claim 1, further comprising
a plunger arranged inside the hollow longitudinal main body and being configured to move in the longitudinal direction of the hollow longitudinal main body, in particular in an axial direction of the hollow longitudinal main body, wherein the hollow longitudinal main body includes a cylindrical shape.

9. The apparatus according to claim 1, wherein
the switching mechanism includes a movable member being configured to move in the longitudinal direction of the hollow longitudinal main body, in particular in an axial direction of the hollow longitudinal main body, wherein the hollow longitudinal main body includes a cylindrical shape.

10. The apparatus according to claim 9, wherein
the movable member of the switching mechanism is configured to move in the longitudinal direction of the hollow longitudinal main body between a first stable position, in particular a retracted stable position relative to a fixed member of the switching mechanism, and a second stable position, in particular a retracted position relative to a fixed member of the switching mechanism.

11. The apparatus according to claim 10, wherein
the movable member of the switching mechanism is positioned in the first stable position when the switching mechanism is in the first state, and
the movable member of the switching mechanism is positioned in the second stable position when the switching mechanism is in the second state.

12. The apparatus according to claim 9, wherein
the vibration member is fixedly held between the plunger and the movable member of the switching mechanism when the switching mechanism is in the second state.

13. The apparatus according to claim 12, wherein
a holding member is fixedly attached to the movable member of the switching mechanism on a side facing the vibration member, and
the vibration member is fixedly held between the plunger and the holding member when the switching mechanism is in the second state, in particular such that an axial position of the vibration member is fixedly held between the plunger and the holding member when the switching mechanism is in the second state and/or a radial position of the vibration member is fixedly held between the plunger and the holding member when the switching mechanism is in the second state.

14. The apparatus according to claim 1, wherein
the vibration member is a spherical ball member, in particular a ball member including metal or being made from metal.

15. A shower head comprising:
an apparatus, comprising:
a hollow longitudinal main body,
a water inlet arranged on one side of the hollow longitudinal main body,
one or more water outlets arranged on another side of the hollow longitudinal main body,
a vibration member arranged inside the hollow longitudinal main body along a water path between the water inlet and the one or more water outlets, and
a switching mechanism configured to switch between a first state, in which the vibration member is movably released inside at least a portion of the hollow longitudinal main body, and a second state, in which a position of the vibration member is fixed.
